(19) United States
(12) Patent Application Publication
(10) Pub. No.: US 2010/0082404 A1
(43) Pub. Date: Apr. 1, 2010

(54) SYSTEM AND METHOD FOR UTILIZING DATE CONSTRAINTS IN AN ADVERTISEMENT SERVING SYSTEM

(75) Inventors: Chad Brower, Campbell, CA (US); Ramana Yerneni, Cupertino, CA (US); Erik Vee, San Mateo, CA (US); Serguei Vassilvitskii, New York, NY (US); Jayavel Shanmugasundaram, Santa Clara, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/242,628

(22) Filed: Sep. 30, 2008

(51) Int. Cl. G06Q 10/00; G06Q 50/00

(52) U.S. Cl. 705/10; 705/7

(57) ABSTRACT

Generally, embodiments of the present invention provide for methods, systems and computer program products for utilizing date constraints in an advertisement serving system. The method according to one embodiment of the present invention comprises receiving a request for one or more advertisements that satisfy one or more constraints. A set of advertisement contracts is generated, wherein the set of advertisement contracts comprise one or more advertisement contracts that satisfy the one or more constraints. The contractual time period for a given advertisement contract in the set of advertisement contracts is then determined. A subset of advertisement contracts is then generated, wherein the subset of advertisement contracts comprises the advertisement contracts in the set of advertisement contracts that are active on a given date. The subset of advertisement contracts is then inputted into an optimization algorithm and one or more advertisement contracts are selected by the optimization algorithm.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to advertisement tags. More specifically, the present invention provides systems, methods and computer program products for utilizing date constraints in an advertisement serving system.

### BACKGROUND OF THE INVENTION

The World Wide Web provides access to an extraordinarily large collection of information sources (in various formats including text, images, videos, other media content and combinations thereof) relating to virtually every subject imaginable. Advertising has become the economic foundation of the World Wide Web, with many websites relying on revenue generated by the placement of advertisements on websites as a primary or otherwise important source of income.

Traditionally, advertisers have a pre-existing agreement, known as an advertisement contract, with an advertisement provider to display online advertisements in association with one or more web pages. Online advertisements are usually displayed on web pages as a result of a request for one or more advertisements through the use of advertisement tags that are provided by publishers and associated with web pages. Advertisement requests, as well as the subsequent display or inclusion of advertisements on web pages, are handled by an ad serving system.

As online advertising continues to grow, the number of available advertisement contracts that are to be satisfied by advertisement providers has also grown at an exponential rate. The result is that obligations of the advertisement provider to display advertisements under the advertisement contracts have also exponentially increased. In order for an advertisement provider to efficiently satisfy its obligations under the voluminous number of advertisement contracts, an advertisement provider is in need of systems, methods and computer program products that prioritize the order in which advertisement contracts are to be satisfied.

### SUMMARY OF THE INVENTION

Generally, embodiments of the present invention provide for methods, systems and computer program products for utilizing date constraints in an advertisement serving system. One embodiment of the present invention is directed towards a method for utilizing date constraints in an advertisement serving system that comprises receiving a request for one or more advertisements that satisfy one or more constraints. A set of advertisement contracts is generated, wherein the set of advertisement contracts comprise one or more advertisement contracts that satisfy the one or more constraints. The contractual time period for the one or more advertisement contracts in the set of advertisement contracts is then determined. A subset of advertisement contracts is then generated, wherein the subset of advertisement contracts comprises the one or more advertisement contracts in the set of advertisement contracts that are active on a given date. The subset of advertisement contracts is then inputted into an optimization algorithm and one or more advertisement contracts that satisfy that one or more constraints are selected by the optimization algorithm.

In utilizing date constraints in an advertisement serving system, embodiments of the present invention provide solutions to the need for a systems and methods that prioritize the order upon which such advertisement contracts are to be satisfied

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for utilizing date constraints in an advertisement serving system according to one embodiment of the present invention;

FIG. 2 illustrates a flow diagram presenting a method for utilizing date constraints in an advertisement serving system according to one embodiment of the present invention; and

FIG. 3 illustrates a flow diagram presenting a method for utilizing date constraints in an advertisement serving system according to another embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

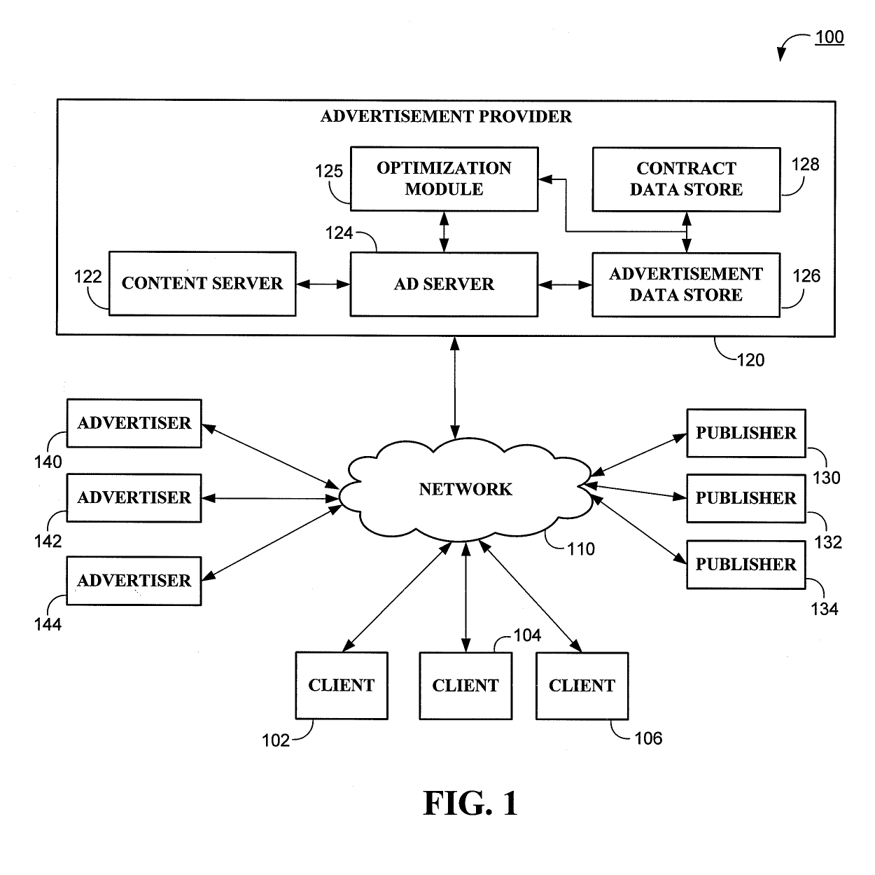

FIG. 1 illustrates one embodiment of a system 100 for utilizing date constraints in an advertisement serving system, the system 100 includes a computer network 110, an advertisement provider 120, a first client 102, a second client 104 and a third client 106, a first publisher 130, a second publisher 132 and a third publisher 134, a first advertiser 140, a second advertiser 142 and a third advertiser 144. In the present embodiment, the advertisement provider 120 comprises a content server 122, an ad server 124, an optimization module 125, an advertisement data store 126 and a contract data store 128.

The computer network 110 may be any type of computerized network capable of transferring data, such as the Internet. According to one embodiment of the invention, the first client device 102, the second client device 104 and the third client device 106 are general purpose personal computers comprising a processor, transient and persistent storage devices, input/output subsystem and bus to provide a communications path between components comprising the general purpose personal computer. Other client devices are considered to fall within the scope of the present invention including, but not limited to, hand held devices, set top terminals, mobile handsets, PDAs, etc. The present invention is not limited to only the client devices 102, 104 and 106 and may comprise additional, disparate client devices. The client devices 102, 104 and 106 are therefore presented for illustrative purposes representative of multiple client devices.

According to one embodiment of the invention, the content server 122, the ad server 124, the publishers 130, 132 and 134 and the advertisers 140, 142 and 144 are programmable processor-based computer devices that include persistent and transient memory, as well as one or more network connection ports and associated hardware for transmitting and receiving data on the network 110. The content server 122, ad server 124, the publishers 130, 132 and 134, the advertisers 140, 142 and 144 may host websites, store data, serve ads, etc. Those of skill in the art understand that any number and type of content server 122, ad server 124, publishers 130, 132 and 134, and advertisers 140, 142 and 144 may be connected to the network 110.

The optimization module 125 at the advertisement provider 120 may comprise one or more processing elements operative to perform processing operations in response to executable instructions, collectively as a single element or as various processing modules, which may be physically or logically disparate elements. The advertisement data store 126 and the contract data store 128 may be one or more data storage devices of any suitable type that is operative to store corresponding data therein. Those of skill in the art recognize that the advertisement provider 120 may utilize more or fewer components and data stores and that any given component or data store at the advertisement provider 120 may be local or remote with regard to another given component or data store.

In accordance with one embodiment, client devices 102, 104 and 106, publishers 130, 132 and 134, advertisers 140, 142, and 144, and the advertisement provider 120 are communicatively coupled to the computer network 110. In accordance with one embodiment, advertisers 140, 142, and 144 may communicate across the network 110 to submit a request to the advertisement provider 120 for one or more advertisement contracts specifying a specific advertisement target. More specifically, a request from a given advertiser for an advertisement target may specify certain contextual constraints for an advertisement opportunity that is to be viewed by an end user satisfying such constraints. For example, the request from the given advertiser may specify that the advertisement target should be California males expressing an interest in sports and autos.

The advertisers 140, 142, and 144 may book one or more advertisement contracts through the content sever 122 of the advertisement provider 120 for transmission to the ad server 124. According to one embodiment, the content server 122 provides an interface through which a given advertiser 140, 142 and 144 may communicate with the advertisement provider 120 to book the one or more advertisement contracts. The contract data store 128 may maintain the one or more advertisement contracts, with a given advertisement contract encoded with or otherwise specifying the constraints for the advertisement target.

The client devices 102, 104 and 106 may retrieve for display one or more content items that the publishers 130, 132 and 134 maintain, such as a news website, an online shopping website, an auction website, a blog website, etc. The one or more content items that a given client device 102, 104 and 106 displays may comprise data indicating the existence of an advertisement opportunity, where an advertisement may be displayed on a given content item. The advertisement opportunity may include information about a user viewing the content item, an address (such as a URL) of the content item that the user is accessing, etc.

The client devices 102, 104 and 106 may communicate across the network 110 with the advertisement provider 120 by transmitting information indicating the advertisement opportunity. Specifically, the client devices 102, 104 and 106 may transmit one or more requests for advertisements to the ad server 124 of the advertisement provider 120. The ad server 124 may acknowledge the receipt of the advertisement opportunity, as well as pass the advertisement opportunity to the optimization module 125.

Upon receipt of the advertisement opportunity, the optimization module 125 may search the repository of advertisement contracts that the contract data store 128 is operative to maintain. The contract data store 128 may maintain one or more advertisement contracts that comprise contractual information for use by the advertising system 100 and relating to terms and conditions for the placement of one or more advertisements that are provided in response to the advertisement opportunity. Specifically, the contractual information may include, in part, certain requirements, referred to as contextual constraints, which serve to indicate a target audience that the advertiser is seeking in the advertising contract.

Continuing with the above exemplary illustration, the advertisement contract may specify that the advertisement target is California males expressing an interest in sports and autos. The advertisement contract may also include a date range upon which the advertisement contract is active. Continuing with the previous example, assume that the advertisement contract specifies that the advertisement target is California males expressing an interest in sports and autos during a contractual time period that is active for a six month period from Jul. 1, 2008 to Dec. 31, 2008.

According to one embodiment of the present invention, the advertisement data store 126 of the advertiser provider 120 is operative to maintain one or advertisements provided by the advertisers 140, 142 and 144 and associated with a given advertisement contract in the contract data store 128. The optimization module 125 is operative to develop a delivery plan to deliver one or more advertisements stored in the advertisement data store 128 (and associated with the one or more advertisement contracts) in response to the one or more the advertisement opportunities.

To develop an advertisement delivery plan, the optimization module 125 receives an advertisement opportunity and identifies certain information that the advertisement opportunity provides relating the user that is accessing a content item. Again continuing with the previous example, the optimization module 125 identifies that a user accessing a content item that is providing the advertisement opportunity is a California male expressing an interest in sports and autos. The optimization module 125 according to one embodiment is operative to search the repository of advertisement contracts stored in the contract data store 128 in an attempt to identify one or more advertisement contracts that the advertisement opportunity may satisfy. For example, the optimization module 125 may identify multiple advertisement contracts specifying an advertisement target of a California male expressing an interest in sports and autos. Accordingly, the optimization module 125 may be operative to aggregate the resultant advertisement contracts into a set or pool of active advertising contracts. For example, the optimization module 125 may aggregate one or more advertisement contracts with the constraints of a California male expressing an interest in sports and autos.

According to one embodiment of the present invention, the advertisement opportunity provides a date upon which the advertisement opportunity is presented to the optimization module 125 through the ad server 124, which the optimization module 125 records as the current date. The optimization module 125 may be operative to identify one or more advertisement contracts in the set of advertisement contracts with the constraints of a California male expressing an interest in sports and autos that are active on the date of the advertising opportunity. For example, a user accessing a content item on Aug. 17, 2008 would generate an advertisement opportunity for presentation to the ad server 124 for selection of advertisement contract that has a contractual time period that covers Aug. 17, 2008, which would be categorized as an active advertisement contract.

The optimization module 125 may be operative to aggregate one or more advertisement contracts that are active on the current date into a subset or narrower pool. Continuing from the previous example, the optimization module 125 may aggregate one or more advertisement contracts in the set of advertisement contracts with the constraints of a California male expressing an interest in sports and autos that are active on Aug. 17, 2008. The optimization module may then use the subset of advertising contracts that satisfy the contextual constraints and that are active on the current date as an input to an optimization algorithm. The optimization algorithm is operative to select one or more advertisement contracts from the subset that are to be returned in response to the request for the one or more advertisements presented by the advertisement opportunity. Although the optimization algorithm is outside of the scope of the present invention, a detailed description of the optimization algorithm may be found in commonly-owned, co-pending U.S. Patent Application No. ______ entitled “SYSTEM AND METHOD FOR OPTIMALLY ALLOCATING OVERLAPPING INVENTORY,” which is hereby incorporated herein by reference in its entirety.

In addition to the foregoing arrangement, the optimization module 125 may be operative to execute in an off-line manner in which the optimization is run periodically, e.g., every few hours, with the optimization engine 125 sending a set of active advertisement contracts to the ad server 124. According to this embodiment, the optimization module 125 selects active contracts for the day in advance of receipt of a given advertisement request. For example, the optimization module 125 may be operative to search the repository of advertisement contracts stored in the contract data store 128 in an attempt to identify advertisement contracts that satisfy a given potential advertisement opportunity. Various permutations such as this should be apparent to those of skill in the art.

The output of the optimization algorithm, which may comprise one or more selected advertising contracts, may be transmitted from the optimization module 125 to the ad server 124. The ad server 124 according to one embodiment is operative to locate the advertisement associated with the one or more selected advertisement contracts in the advertisement data store 126. The ad server 124 may transmit the advertisement(s) to the given requesting client device 102, 104 or 106 via the network 110 for display with a content item provided by the publisher 130, 132 or 134 that is displayed to an end user of the client device 102, 104 or 106.

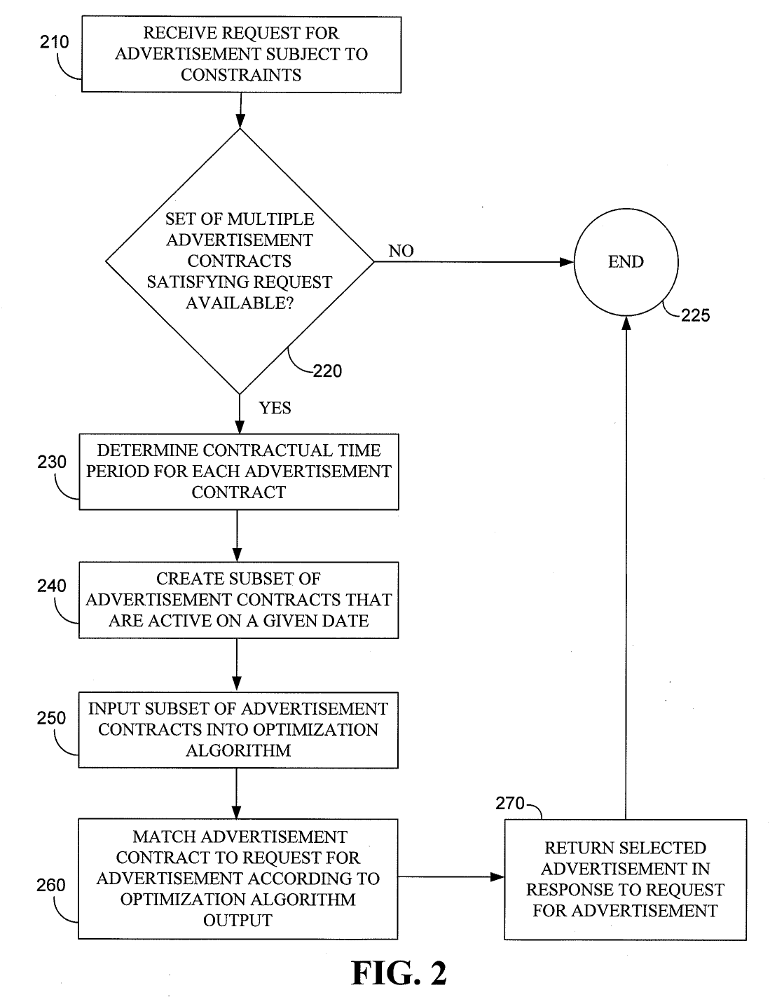

FIG. 2 presents a flow diagram illustrating a method for utilizing date constraints in an advertisement serving system according to one embodiment of the present invention. In accordance with the embodiment of FIG. 2, the method may begin by receiving a request for an advertisement subject to certain contextual constraints, step 210. Contextual constraints may comprise, for example, an advertising target who is a California male who has an interest in sports and autos. According to one embodiment, the end user may have an associated user profile that indicates information regarding a given user, e.g., that the end user is a California male who expresses an interest in sports and autos.

A determination is made as to whether a set of one or more advertisement contracts are available that satisfy the constraints associated with the request for an advertisement, step 220. For example, an ad server may receive a request for an advertisement subject to certain constraints, which uses an optimization module to subsequently search a repository of advertisement contracts to determine whether one or more advertisement contracts exist that satisfy the request for the advertisement. If one or more advertisement contracts are not available, the method terminates, step 225.

Alternatively, the optimization module may be operative to execute in an off-line manner in which the optimization is run periodically, e.g., every few hours. According to this embodiment, the optimization module selects active contracts for a given day in advance of receipt of a given advertisement request. For example, the optimization module in accordance with embodiments of the present method may be operative to search the repository of advertisement contracts stored in the contract data store in an attempt to identify advertisement contracts that satisfy a given potential advertisement opportunity. Various permutations such as this should be apparent to those of skill in the art.

Where one or more advertisement contracts satisfying the request for an advertisement subject to certain constraints are available, process flow continues to step 230, where the contractual time period for a given advertisement contract is determined, e.g., the optimization module determines the active contractual time period for advertisement contracts in the set. For example, one advertisement contract may have a contractual time period beginning on Jul. 1, 2008 and ending on Dec. 31, 2008. A second advertisement contract may have a contractual time period beginning on Aug. 1, 2008 and ending on Nov. 1, 2008.

A subset of advertisement contracts that are active on a given date is selected or otherwise created, step 240. According to one embodiment, the given date is the current date upon which the request for an advertisement is made. A determination may then be made as to those advertisement contracts in the set that are active on the given date, which, continuing from the previous example, would include both the first and second advertisement. A subset of advertisement contracts may include both a first advertisement contract and a second advertisement contract, as well as combinations thereof. The subset of advertisement contracts may be set as input to an optimization algorithm, step 250.

According to one embodiment, the optimization algorithm uses the subset of advertisement contracts containing both the first and second advertisement contract as the set of contracts to apply the optimization algorithm to determine an advertisement for selection. The optimization algorithm generates an advertisement contract that matches the request for the advertisement as an output, step 260, returning the selected advertisement in response to the request, step 270 and terminating the process, step 225. For example, the optimization algorithm passes the output of a selected advertisement contract to the ad server, which in turn searches the repository of advertisements to locate and return an advertisement associated with the selected advertisement contract.

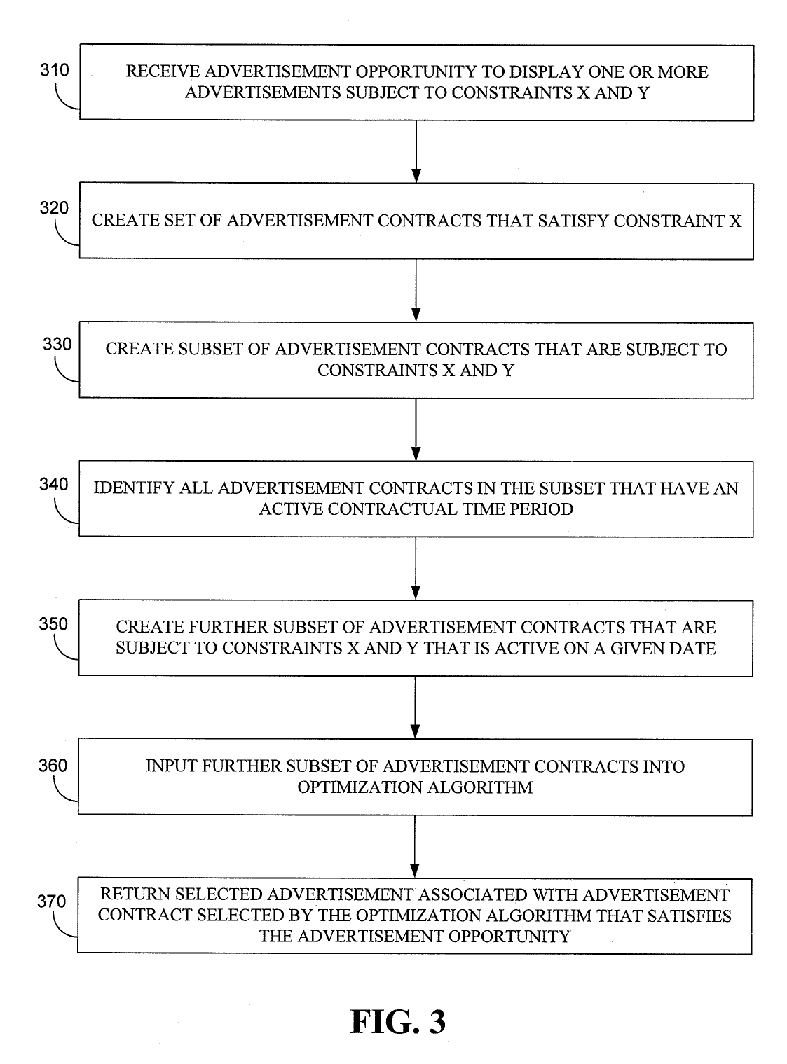

FIG. 3 presents a flow diagram illustrating a method for utilizing date constraints in an advertisement serving system according to one embodiment of the present invention. In accordance with the embodiment of FIG. 3, the method may begin by receiving an advertisement opportunity to display one or more advertisements subject to constraints X and Y, step 310. For example, an ad server may receive a request for an advertisement where the advertisement target is both a male and expresses an interest in sports. A set of advertisement contracts that satisfy constraint X is created, step 320. Continuing with the previous example, as set of advertisement contracts is located by the ad server using an optimization module, which advertisement contracts are targeted to males. A subset of advertisement contracts derived from the initial set of advertisement contracts that are subject to both constraints X and Y is created, step 330. For example, a further subset of advertisement contracts may carved out from the set of advertisement contracts that are targeted to males to include advertisement contracts that are targeted to males who also have express an interest in sports.

Advertisement contracts in the subset that have a currently active contractual time period are identified, step 340. For example, the contractual time period for a given advertisement contract in the subset of advertisement contracts that are targeted to males who also have an interest in sports is determined. One advertisement contract may have a contractual time period beginning on Jul. 1, 2008 and ending on Dec. 31, 2008. A second advertisement contract may have a contractual time period beginning on Aug. 1, 2008 and ending on Nov. 1, 2008. A further subset of advertisement contracts that are subject to both constraints X and Y that are active on a given date is created, step 350. As presented previously, a given date may the current date upon which the advertisement opportunity was submitted. For example, if the current date is Sep. 17, 2008, both the first and second advertisement contract would be included in the further subset. The further subset of advertisements contracts is then set as the input into an optimization algorithm, step 360. An advertisement associated with the advertisement contract selected by the optimization algorithm that satisfies the advertisement opportunity is returned, step 370.

In accordance with the foregoing description, the present invention provides systems, methods and computer program products for utilizing date constraints in an advertisement serving system. In utilizing date constraints in an advertisement serving system, embodiments of the present invention provide solutions to the need for a systems and methods that prioritize the order upon which such advertisement contracts are to be satisfied.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed:

1. A method for utilizing date constraints in an advertisement serving system, the method comprising:
generating a set of advertisement contracts, wherein the set of advertisement contracts comprise one or more advertisement contracts that satisfy the one or more constraints;
determining the contractual time period for the one or more advertisement contracts in the set of advertisement contracts;
generating a subset of advertisement contracts, wherein the subset of advertisement contracts comprises the one or more advertisement contracts in the set of advertisement contracts that are active on a given date;
inputting the subset of advertisement contracts into an optimization algorithm; and
selecting one or more advertisement contracts that satisfy that one or more constraints by the optimization algorithm.

2. The method of claim 1, wherein the one or more constraints further comprises one or more characteristics of an end user.

3. The method of claim 2, wherein the one or more characteristics of an end user are selected from a group consisting of gender, location, interest, marital status, employment status and nationality.

4. The method of claim 1, wherein the given date comprises a date that a request for one or more advertisements that satisfy the one or more constraints is received.

5. The method of claim 1, wherein selecting one or more advertisement contracts that satisfy that one or more constraints comprises:
selecting one or more advertisements associated with the selected one or more advertisement contracts; and
returning the one or more selected advertisements that satisfy that one or more constraints.

6. Computer readable media comprising program code that when executed by a programmable processor causes the programmable processor to execute a method for utilizing date constraints in an advertisement serving system, the computer readable media comprising:
program code for generating a set of advertisement contracts, wherein the set of advertisement contracts comprise one or more advertisement contracts that satisfy the one or more constraints;
program code for determining the contractual time period for the one or more advertisement contracts in the set of advertisement contracts;
program code for generating a subset of advertisement contracts, wherein the subset of advertisement contracts comprises the one or more advertisement contracts in the set of advertisement contracts that are active on a given date;
program code for inputting the subset of advertisement contracts into an optimization algorithm; and
program code for selecting one or more advertisement contracts that satisfy that one or more constraints by the optimization algorithm.

7. The computer readable media of claim 6, wherein the one or more constraints further comprises one or more characteristics of an end user.

8. The computer readable media of claim 7, wherein the one or more characteristics of an end user are selected from a group consisting of gender, location, interest, marital status, employment status and nationality.

9. The computer readable media of claim 6, wherein the given date comprises a date that a request for one or more advertisements that satisfy the one or more constraints is received.

10. The computer readable media of claim 6, wherein program code for selecting one or more advertisement contracts that satisfy that one or more constraints comprises:
program code for selecting one or more advertisements associated with the selected one or more advertisement contracts; and
program code for returning the one or more selected advertisements that satisfy that one or more constraints.

11. A system for utilizing date constraints in an advertisement serving system, the system comprising:
an advertisement server operative to receive a request for one or more advertisements that satisfy one or more constraints; and
an optimization module operative to:
generate a set of advertisement contracts, wherein the set of advertisement contracts comprise one or more advertisement contracts that satisfy the one or more constraints,
determine the contractual time period for the one or more advertisement contracts in the set of advertisement contracts,
generate a subset of advertisement contracts, wherein the subset of advertisement contracts comprises the one or more advertisement contracts in the set of advertisement contracts that are active on a given date,
input the subset of advertisement contracts into an optimization algorithm, and
select one or more advertisement contracts that satisfy that one or more constraints by the optimization algorithm.

12. The system of claim 11, wherein the one or more constraints further comprises one or more characteristics of an end user.

13. The system of claim 12, wherein the one or more characteristics of an end user are selected from a group consisting of gender, location, interest, marital status, employment status and nationality.

14. The system of claim 11, wherein the given date comprises a date that the request for one or more advertisements that satisfy the one or more constraints is received.

15. The system of claim 11, wherein the advertisement server is operative to:
select one or more advertisements associated with the selected one or more advertisement contracts; and
return the one or more selected advertisements that satisfy that one or more constraints.
